(19) United States
(12) Patent Application Publication
(10) Pub. No.: US 2025/0313025 A1
(43) Pub. Date: Oct. 9, 2025

(54) COOLING DEVICE INCLUDING HEAT PIPES FOR IMPROVED HEAT REMOVAL EFFICIENCY IN A PRINTING SYSTEM

(71) Applicant: Xerox Corporation, Norwalk, CT (US)

(72) Inventors: Ali R. Dergham, Fairport, NY (US); Alex Talevski, Penfield, NY (US); Robert Alan Clark, Williamson, NY (US); Patrick J. Howe, Fairport, NY (US); Alan Conner, Rochester, NY (US)

(73) Assignee: Xerox Corporation, Norwalk, CT (US)

(21) Appl. No.: 18/627,965

(22) Filed: Apr. 5, 2024

(51) Int. Cl. B41J 29/377; B41J 11/00; B41M 7/00; F28D 15/02

(52) U.S. Cl. CPC B41J 29/377; B41J 11/002; B41M 7/009; F28D 15/0275

(57) ABSTRACT

A cooling device suited to cooling sheets includes at least one drum which is mounted for rotation about a central axis. The drum includes a cylindrical wall which defines an outer surface and an inner surface. A plurality of heat pipes extend into an interior of the drum from the inner surface of the cylinder wall. The cooling device may be incorporated into a printing device and configured for cooling printed sheets prior to the sheets entering an inkjet marking device.

### BACKGROUND

The exemplary embodiment relates to printing systems and finds particular application in connection with a cooling device for removing excess heat from printed pages.

Production inkjet printers typically use heat to dry the ink on one side of a paper sheet before flipping it to print the other side for duplex printing. The heated paper passing near the printheads could heat them to above their intended operating point. To prevent that from occurring, excess heat is removed from the paper using a cooling device, such as a cooling drum. The heat transfers via conduction from the paper to the drum surface, which is typically made of aluminum, and then via convection to air that is flowing through the center of the drum and exhausted from an outlet. Cooling fins are sometimes used to increase the surface area and increase the convection rate. However, the rate of conduction of heat from the base to the tip of the cooling fins limits the cooling efficiency. As a result, the printer may need to operate at a lower speed than it could otherwise handle. For heavyweight sheets (e.g., sheets of 200 gsm/500 sheets, and above), it becomes more difficult to reduce the sheet temperature to an appropriate temperature for printing.

There remains a need for a cooling device which Improves the rate of heat removal from the printed sheets.

### INCORPORATION BY REFERENCE

The following references, the disclosures of which are incorporated by reference in their entireties, are mentioned:

U.S. Pub. No. 20110102491A1, published May 5, 2011, by Kovacs, et al., describes an inkjet printer which includes a cooler positioned proximate a media path to cool an ink receiving member prior to ink being ejecting from a printhead onto the ink receiving member.

U.S. Pub. No. 20140198164 A1, published Jul. 17, 2014, by Thayer, et al., describes an inkjet offset printer which includes an image receiving drum with a heating and a cooling system located in an internal cavity of the drum.

U.S. Pub. No. 20150220052 A1, published Aug. 6, 2015, by Facchini, II, et al., describes a system for cooling and de-curling output image receiving media substrates prior to stacking them in an output tray of an image forming device. The substrates contact a rotating cooling drum which may include an outer heat dissipating layer, an active Peltier cooling layer and an inner heat sink layer incorporating heat sink protrusions which extend radially inward.

U.S. Pub. No. 20150273872 A1, published Oct. 1, 2015, by Fukumoto, et al., describes a cooling device for cooling an attachment body on which an ultraviolet curable composition from an ejection head is received and cured.

U.S. Pub. No. 20230183017 A1, published Jun. 15, 2023, by Keyes, describes a tensioner assembly for a belt for example, in a printing device cooler.

U.S. Pat. No. 9,827,797, issued Nov. 28, 2017, by Boland, et al., describes a set of air-cooled rollers that cool a print medium downstream of a dryer while minimizing the temperature differentials across the print medium.

### BRIEF DESCRIPTION

In accordance with one embodiment, a cooling device for cooling sheets includes a drum mounted for rotation about a central axis. The drum includes a cylindrical wall which defines an outer surface and an inner surface. A plurality of heat pipes extend into an interior of the drum from the inner surface of the cylinder wall.

In accordance with another embodiment, a printing device includes a cooling device as described above, a first inkjet marking device, a dryer which heats sheets that have been printed with the inkjet marking device, the cooling device receiving heated sheets from the dryer, and a paper path which transports sheets from the cooling device to one of the first inkjet marking device and a second inkjet marking device.

In accordance with another embodiment, a method of printing includes printing a first side of a sheet with a first inkjet marking device and drying the sheet that has been printed with the first inkjet marking device to form a heated sheet. The method further includes cooling the heated sheet with a cooling device which includes a plurality of heat pipes. The heat pipes draw heat from the heated sheet to form a cooled sheet. The cooled sheet is transported from the cooling device to one of the first inkjet marking device and a second inkjet marking device for printing on one of the first side and a second side of the sheet.

In accordance with another embodiment, a method of forming a cooling device includes attaching a plurality of heat pipes to an inner surface of a cylindrical wall of a drum, such that the heat pipes extend into an interior of the drum. The method further includes mounting the drum for rotation about a central axis, connecting a source of cooling air with the interior of the drum, and providing a paper path for sheets to contact an outer surface of the cylindrical wall during rotation of the drum.

### BRIEF DESCRIPTION OF THE DRAWINGS

FIG. 1 is a functional block diagram of an inkjet printer incorporating a cooling device in accordance with one aspect of the exemplary embodiment;

FIG. 2 is a simplified functional block diagram of an inkjet printer incorporating a cooling device in accordance with a second aspect of the exemplary embodiment;

FIG. 3 is an enlarged perspective view of the cooling device of FIG. 1;

FIG. 4 is a cross sectional view of an angled design of heat pipe for use in the cooling device of FIG. 1;

FIG. 5 is a cross sectional view of a linear design of heat pipe for use in the cooling device of FIG. 1;

FIG. 6 is a plan view of a sectioned cooling drum to illustrate positions of grooves for receiving the heat pipes of FIG. 4; and

FIG. 7 illustrates a method which includes cooling the printed sheets with a cooling device incorporating the heat pipes of FIGS. 4 and/or 5 in accordance with another aspect of exemplary embodiment.

### DETAILED DESCRIPTION

Aspects of the exemplary embodiment relate to a sheet cooling system and to a printing device incorporating such a sheet cooling system. The sheet cooling system includes a plurality of heat pipes on the interior of a cooling cylinder or drum. The heat pipes assist in dissipating heat from heated sheets as they make contact with the cooling drum.

As used herein, a printing device can include any device for rendering an image on print media, such as a copier, laser printer, bookmaking machine, facsimile machine, or a multifunction machine (which includes one or more functions such as scanning, printing, archiving, emailing, and faxing). “Print media” can be a usually flimsy physical sheet of paper, plastic, or other suitable physical print media substrate for images.

A “document” is used herein to mean an electronic (e.g., digital) or physical (e.g., paper) recording of information. In its electronic form, a document may include image data, audio data, or video data. Image data may include text, graphics, or bitmaps. An image generally may include information in electronic form which is to be rendered on the print media by the image forming device and may include text, graphics, pictures, and the like. The operation of applying images to print media, for example, graphics, text, photographs, etc., is generally referred to herein as printing or marking.

“Duplex printing” refers to printing images on both image-receiving surfaces of a sheet of print media.

An inkjet printing device ejects liquid ink from printheads onto a receiver surface, such as a print medium, such as paper, or an intermediate transfer surface, to form images. The printheads each include an array of inkjets or “nozzles” which are selectively actuated to provide a droplet of ink, which is directly or indirectly deposited on the print medium. Various types of inks are used in inkjet printers and include liquid inks that are liquid at room temperature and solid inks that are heated to a temperature at which they can be ejected from the nozzles. Inks typically include a colorant dispersed or dissolved in a solvent. Examples of such solvents include organic solvents and aqueous solvents, such as water. The inks may be configured to be cured or dried by heat.

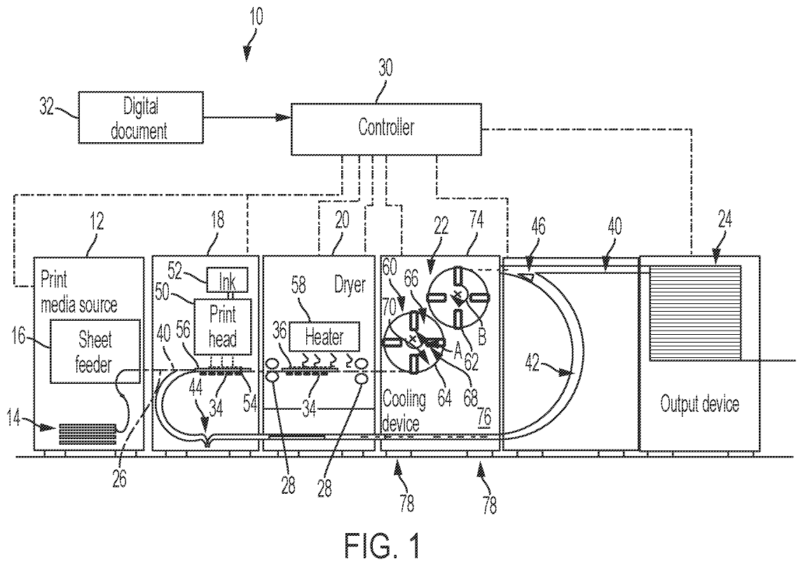

With reference to FIG. 1, an illustrative inkjet printing device 10 includes a source 12 of print media sheets 14, a sheet feeder 16, at least one marking device 18, a sheet dryer 20, a cooling device 22, and an output device 24, all connected by a print media path 26. A sheet transport system 28 conveys the print media sheets along the print media path, downstream from the sheet feeder 16 and ultimately to the output device 24. A controller 30 controls the operation of the components 16, 18, 20, 22, 24, and 28 of the printing device 10, and provides instructions for rendering a digital document 32 as printed images 34, 36 on opposite sides of the print media sheets 14. In particular, the controller sends instructions for rendering pages of a print job 38 to one or more marking devices 18 for printing.

The illustrated print media path 26 is configured for simplex or duplex printing. In particular, the print media path 26 includes a main path 40, which connects the sheet feeder 16 with the marking device 18, dryer 20, cooling device 22, and output device 24, and a return (or duplex) path 42, which connects the main path 40, downstream of the dryer 20, with the main path 40, at a location upstream of the marking device 18. The return path 42 directs already printed and dried sheets to the same marking device 18 for printing and may include an inverter 44 for inverting the sheets prior to returning them to the marking device 18. A diverter 46 in the main path 40 controls whether sheets are directed into the return path 42 or continue along the main path 40. The sheet transport system 28 includes components for transporting the sheets along the paths 40, 42, etc., such as rollers, conveyor belts, air jets, combinations thereof, and the like.

While the cooling device 22 is illustrated in FIG. 1 as being in the main path 40, between the dryer 20 and the diverter 46, in other embodiments, part or all of the cooling device 22 may be located in the main path 40, between the sheet feeder 16 and the marking device 18, or in the return path 42, such that the cooling device is positioned intermediate the dryer and the marking device for cooling at least those printed sheets that are to be duplex printed.

The illustrated marking device 18 includes one or more printheads 50, which eject droplets of ink 52, in liquid form, directly onto an image receiving surface 54 or 56 of one of the sheets 14 of print media to form the printed image 34, as illustrated. Alternatively, the printhead ejects ink onto an intermediate transfer member, such as a belt or drum (not shown) from which the formed image is transferred to the print media sheet.

The printheads 50 typically each include an array of individual nozzles through which drops of ink are ejected across an open gap to the image receiving surface to form an ink image during printing. In an inkjet printhead, individual piezoelectric, thermal, or acoustic actuators generate mechanical forces that expel the ink through the nozzle, in a faceplate of the printhead. The actuators expel an ink drop in response to an electrical signal. The magnitude, or voltage level, of the firing signals affects the amount of ink ejected in an ink drop. The firing signal is generated with reference to image data by a printhead controller, which may be incorporated in or separate from the controller 30. The marking device (or controller 30) processes the image data to identify the inkjets in the printheads of the printing device that are operated to eject a pattern of ink drops at particular locations on the image receiving surface to form an ink image corresponding to the image data. The locations where the ink drops landed are sometimes called “ink drop locations,” “ink drop positions,” or “pixels.” Thus, a printing operation can be viewed as the placement of ink drops on an image receiving surface with reference to electronic image data.

The liquid ink 52 may be selected from aqueous inks, liquid ink emulsions, pigmented inks, phase change inks in a liquid phase, and gel or solid inks having been heated or otherwise treated to alter the viscosity of the ink for improved jetting. Ejecting ink with the printhead 50 may include ejecting ink with thermal ink ejectors or piezoelectric ink ejectors.

The dryer 20 applies heat to fix the printed image(s) 36, 38 more permanently to the sheet 14. In particular, the ink ejected onto the print media dries, solidifies, gelatinizes, freezes, changes phase, increases in viscosity, and/or otherwise stabilizes before the ink penetrates the sheet sufficiently to produce show-through on a reverse side of the sheet.

In one embodiment, the dryer 20 circulates hot air, which heats the sheet 14 and the printed image 34, 36, causing water and/or non-aqueous solvent(s) to evaporate from the ink. In one embodiment, the dryer 20 includes a heater 58, such as a source of infrared energy, which heats the sheet from above the printed side. In other embodiments, the dryer includes a heated platen (not shown), which supports the sheet and thus heats the sheet from the other side.

The illustrated in-line cooling device 22 is positioned intermediate the dryer 20 and the marking device 18 to reduce the temperature of the dried sheets prior to marking them (again) with the marking device 18 (duplex printing). The illustrated cooling device 22 includes at least one cooling member, such as a drum 60, 62, which defines a sheet-contacting outer surface 64. Disposed within an interior 66 of each drum are heat pipes 68 which carry the heat away from an inner surface 70 of the drum wall and are described in greater detail below.

The output device 24 may include one or more trays, stackers, and the like. One or more finishing devices (not shown) may be positioned in the main path, either within or upstream of the output device 24.

Some or all of the components 12, 18, 20, 22, 24 of the printing device 10 may be separable modular units, each with a respective housing, e.g., as shown at 74 for the cooling device 22. In one embodiment, the housing 74 may be insulated to define a temperature-controlled interior 76. Each housing 74 may be mounted on casters, wheels, or other rotatable devices 78, which allow the housing 74 and its contents to be moved to a different location and/or replaced. Additional modular units may be added, such as additional cooling device modules.

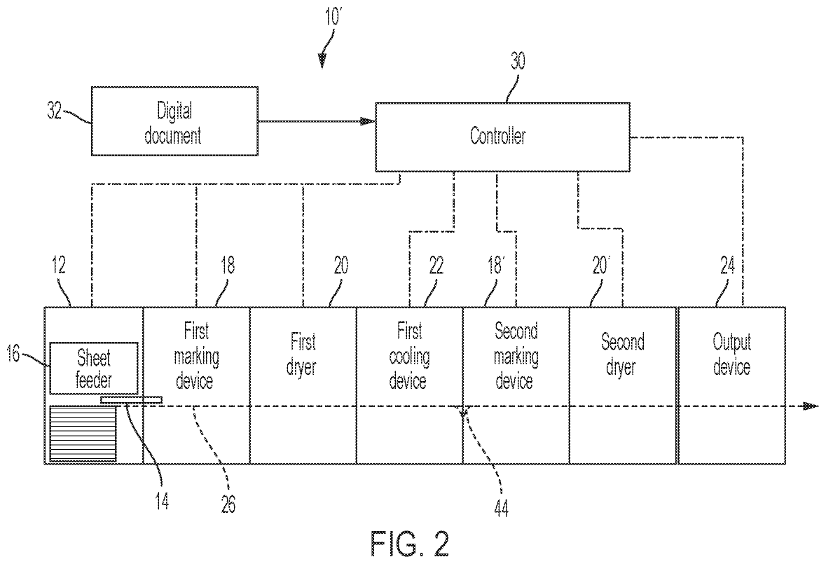

FIG. 2 illustrates a printing device 10′, in simplified form, which may be similarly configured to the device of FIG. 1, except as noted. Similar elements are accorded the name numerals. In this embodiment, the sheets are inkjet printed, dried, and cooled, as for the embodiment of FIG. 1. In this embodiment, a second marking device 18′, which may be similarly configured to the marking device 18, is located downstream of the cooling device 22. An inverter 44, upstream of the second marking device 18′ inverts the sheets 14 before they are printed on the second side. A second dryer 20′, downstream of the second marking device, may be similarly configured to dryer 20. Optionally, a second cooling device (not shown), which may be similar to cooling device 22 or of a different configuration, may be positioned between the second dryer 20′ and the output device 24.

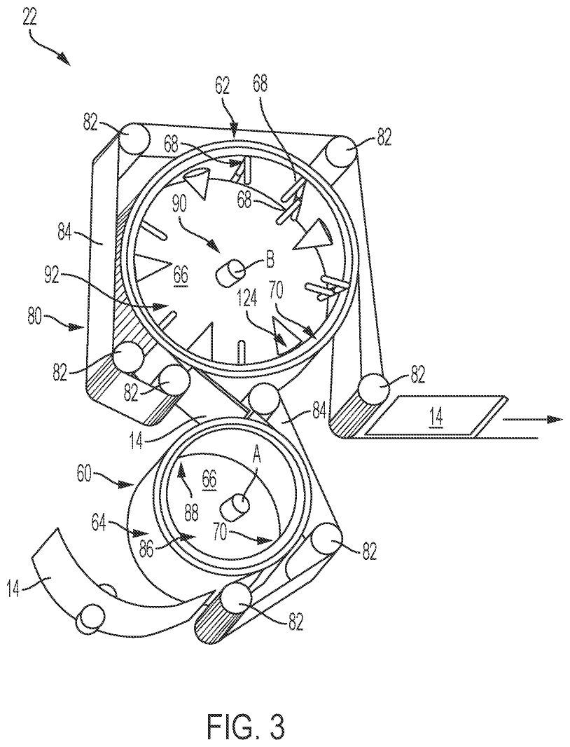

FIG. 3 shows an exemplary cooling device 22 in greater detail. The two counter-rotating drums 60, 62 each have a central axis A, B, around which the drum is rotated by a suitable drive mechanism (not shown). The axes A and B are in parallel with each other and aligned with the cross-process direction of the sheets carried around the drums. The drums 60, 62 are positioned such that the printed sheets 14 are drawn along an s-shaped path defined by their outer surfaces 64, in sequence. A biasing system 80, such as a sequence of rollers 82 and one or more continuous belts 84, biases the sheets 14 into contact with the outer surfaces 64 of the drums. The cylindrical drums may be of the same diameter or different diameters, e.g., depending on the available space for the cooling system or other considerations. The interiors 66 of the drums may be fed with a cooling fluid, such as air or water. In one embodiment, cooling air is circulated through the drum interiors 66 to draw heat from the heat pipes 68. The cooling air may be forced into the interior under slight positive pressure, and/or drawn from the interior under a slight negative pressure, e.g., by a fan, a pump, or the like. The cooling air may be at suitable temperature for withdrawing heat from the heat pipes. It may be air drawn in from the atmosphere surrounding the printer. The air is optionally cooled by a refrigeration unit (not shown) to a desired temperature.

In one embodiment, air enters the interior 66 of a first of the drums 60 through an inlet at a first end 86 of the drum and exits the drum interior through an outlet at a second end 88, which is axially spaced from the first end. The cooling air is then carried by suitable ductwork (not shown) to an inlet at first end 90 of the second drum 62 and exits the interior of the second drum through an outlet at a second end 92, which is axially spaced from the first end. The cooling air is then exhausted from the cooling device housing 74. The ends 86, 88, 90, 92 of the drums may be closed by circular end walls, which define the inlets and outlets, respectively.

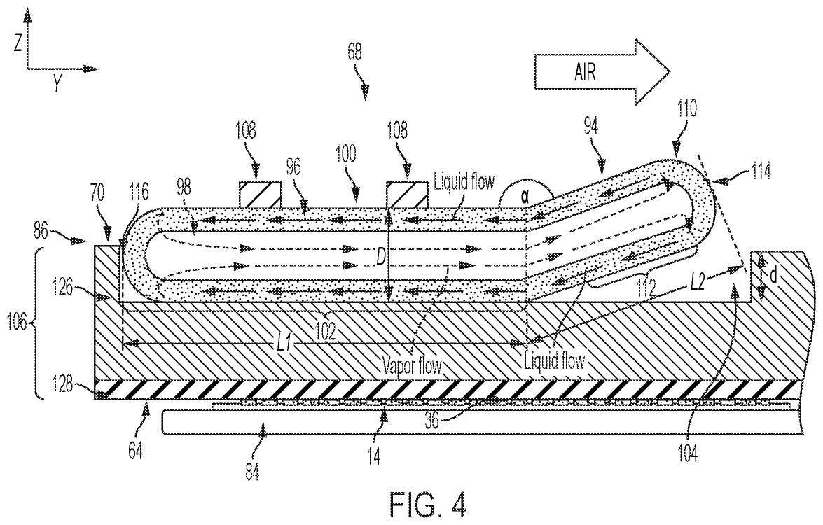

One or both of the drums 60, 60 contains an array of heat pipes 68, such as at least 12, or at least 20, or at least 40 heat pipes, such as up to 500, or up to 200 heat pipes. The heat pipes may be linear or angled (“L-shaped”). FIG. 4 illustrates an angled heat pipe 68. The heat pipe includes a sealed shell 94, which defines an outer surface of the heat pipe. The shell 94 may be formed of a thermally conductive material, such as copper or a copper alloy. Magnesium, aluminum, and titanium may also be used to form the shell. The shell encloses a layer 96 of a wicking material, which may be in direct contact with the shell. The layer 96 may be formed from a sintered copper powder, sintered metal fibers, glass fibers, woven or non-woven cloth, or combination thereof. The wicking material is soaked with a working fluid, which is generally a vaporizable liquid or mixture of liquids, such as water, ethanol, methanol, acetone, nanofluid copper, or mixture thereof. The vaporizable fluid may have a boiling point of up to 110°, or up to 100° C. In one embodiment, deionized water is used as the working fluid. The working fluid may occupy 10% to 30% of the total heat pipe volume, when in the liquid state.

The wicking layer 96 surrounds an open cavity or void space 98 at the core of the heat pipe 68. The inside of the heat pipe is at a partial vacuum, allowing the working fluid to vaporize more easily. A first portion 100 of the heat pipe 68 defines an evaporator zone 102. The first portion 100 has a length L1 and is mounted in a receiving member 104, such as groove, which extends into a cylindrical wall 106 of the cooling drum from the inner surface 70 of the wall. The groove 104 is an indent of depth d, which may be about ⅓ of the diameter D of the heat pipe in the case of a heat pipe with a circular cross section, or ⅓ of the height in the case of a flattened heat pipe. A length of the groove 104 is at least L1 and is greater than its width. The length of the groove may be sufficient to accommodate a single heat pipe or more than one heat pipe, such as at least two, or at least three, or at least four heat pipes. In the case of a round heat pipe, the groove 104 may have an arc-shaped cross section, to match that of the heat pipe. In the case of a flattened heat pipe, the groove may have a rectangular cross section. The first portion 100 of the heat pipe may be retained within the groove 104 by a suitable retaining member or members 108, such as a bracket or an adherent, such as an adhesive, cement, metal solder, or the like. In the case of a bracket, the first portion 100 of the heat pipe may be press-fit into the groove 104 and the bracket may provide a spring tension to retain it in position. In the case of an adherent, such as a solder, the groove may be plated with a material compatible with the adherent. For example, in the case of an aluminum drum and a copper heat pipe shell, the grooves may be plated with nickel. The solder used may be a low temperature solder paste, e.g., based on a tin-bismuth alloy with a melt temperature of about 138° C. Using a low temperature solder with a melting point of no more than 250° C., or no more than 200° C., reduces the risk that the water or other working fluid in the heat pipes will boil and the heat pipes burst. During soldering, the heat pipes may be clamped into the groove until the solder hardens.

A second portion 110 of the heat pipe 68 extends outward from the groove 102, into the interior 66 of the drum and defines an evaporator zone 112. The first and second portions 100, 110 of the heat pipe together define the void space 98. The second portion has a length L2, from the first portion to a tip 114 at a distal end of the heat pipe. The second portion 110 is angled, relative to the first portion 100 of the heat pipe by an angle α, where α is greater than 90° and less than 180°, such as 110-170°. Put another way, the second portion 110 may be positioned at an angle of 45°+/−15° from vertical (Z direction). This angle encourages flow under gravity of the liquid in the heat pipe 68, when the heat pipe is positioned adjacent to the paper sheet 14.

A total length L=L1+L2 of the heat pipe may be from 12 to 25 cm, e.g., about 15 to 20 cm. A ratio of the length L2 of the angled, second portion 110 (furthest from the cylinder wall) to a length L1 of the straight, first portion 100 (adjacent the cylinder wall) may be from 1:4 to 2:1, such as from 1:3 to 1:2. As an example, angled heat pipes of 18 cm in length L may have a first portion 100 of length L1 of about 13 cm and a second portion 110 of length L2 of about 5 cm. Such heat pipes could be used in a drum with an interior diameter of, for example, about 25-30 cm.

The heat pipe 68 may have a substantially circular cross section, with an exterior diameter of from 5 to 20 mm, such as 8 to 10 mm. A thickness of the shell wall may be about 0.3 to 2 mm, thus yielding an interior diameter D of about 3 to 16 mm, such as 6 to 10 mm. In another embodiment, the heat pipes may be flattened in cross section, such that interior diameter D is an average of two mutually perpendicular dimensions, where the smallest dimension is greater than 0 mm. A ratio of L:D may be at least 3:1, or at least 4:1, or at least 5:1, or at least 10:1, or up to 50:1, or up to 20:1.

In operation, as heat reaches the heat pipe 68 from the cylinder wall, evaporator and condenser zones 102, 110 form within the heat pipe. The evaporator zone 102 forms adjacent to a first end 116 of the heat pipe, and proximate to the cylinder wall 106. The condenser zone 110 forms adjacent to the second end 112 of the heat pipe, and furthest from the cylinder wall 104. In the evaporator zone 102, heat from the cylinder wall 104 vaporizes the liquid. This causes it to expand through the open core 98 into the cooler, condenser zone 110, where it condenses and releases its heat. The fluid then flows back through the outer wicking layer 96 via capillary action to complete the cycle. The rate at which the expanding gas moves heat along the core is much faster than the speed at which it would conduct through an equivalent volume of solid material, such as aluminum or copper. The heat is carried away from the heat pipe by the air flowing past the heat pipes.

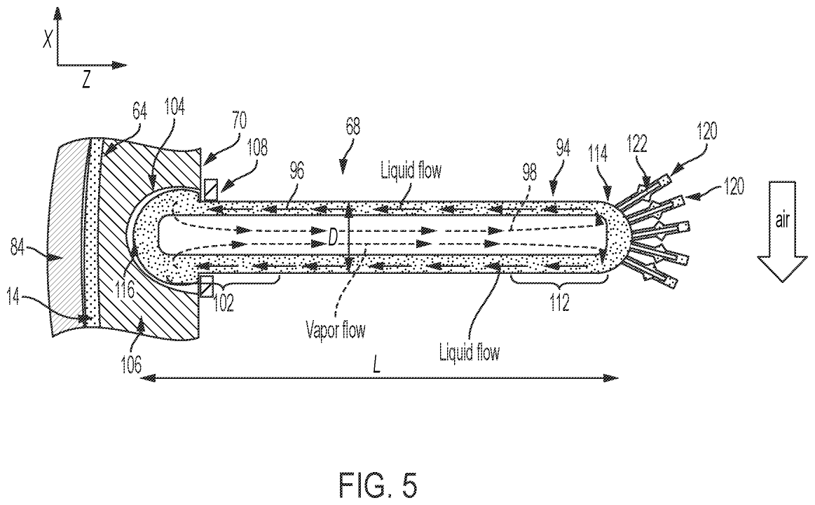

FIG. 5 illustrates an example of a straight heat pipe, which may be similarly configured to the heat pipe of FIG. 4, except as noted. In this embodiment, the groove 104 is in the form of a generally circular socket in the cylinder wall, which receives only the first end 116 of the heat pipe. The overall length L of the heat pipe 68, in this embodiment, may be selected to fit within the interior diameter of the drum, e.g., L may be up to half of the drum radius.

To maximize the surface area accessible to the airflow, the heat pipes of FIG. 4 or FIG. 5 may be configured with a larger surface area, e.g., by providing the condenser end with protrusions 120 containing void spaces 122 and/or wicking material, through which the vapor and liquid can flow to and from the core 98, as illustrated in FIG. 5. These protrusions may be branched or otherwise configured to increase the area of contact of each heat pipe with the airflow. By providing part of the void space within the protrusions, the heat flow can be higher than with similarly constructed, solid protrusions. The protrusions may be formed from copper or other thermally conductive material. In one embodiment, the protrusions are integrally formed with the shell. The more complex structure of a heat pipe with protrusions may be formed by 3D printing methods or using a mold, for example.

In another embodiment, cooling fins, similarly shaped to the protrusions but without voids spaces, may be attached to the tips 114 of the heat pipes.

The drum 60, 62, and protrusions 120 and/or fins, where used, may be formed from a heat-conductive metal or alloy, such as aluminum.

In another embodiment, cooling fins 124 (FIG. 3) may be incorporated into the drum structure itself and extend into the drum interior, in a similar manner to the heat pipes. These cooling fins, formed from aluminum or other conductive material could be integrally formed with the cylinder wall or formed separately and fitted into grooves similar to the grooves for the heat pipes, and/or bonded to the cylinder wall inner surface.

The heat pipe shape could additionally be modified to optimize contact with the drum on one end, and air transfer on the other.

The cylinder wall 106 may be of a single or multilayer construction. For example, as shown in FIG. 4, an inner layer 126 is formed of aluminum or other heat-conductive material and includes grooves 104 which receive the heat pipes 68 therein. An outer layer 128 of the cylinder wall is formed of a different material to the inner layer and aids in distributing heat across the outer surface or performs another function, such as reducing sticking of the ink and/or sheets. In one embodiment, the outer layer is formed of copper and may be relatively thin, such as 0.1 mm or less. In another embodiment, the outer layer is formed from a polymer, such as a silicone-based polymer.

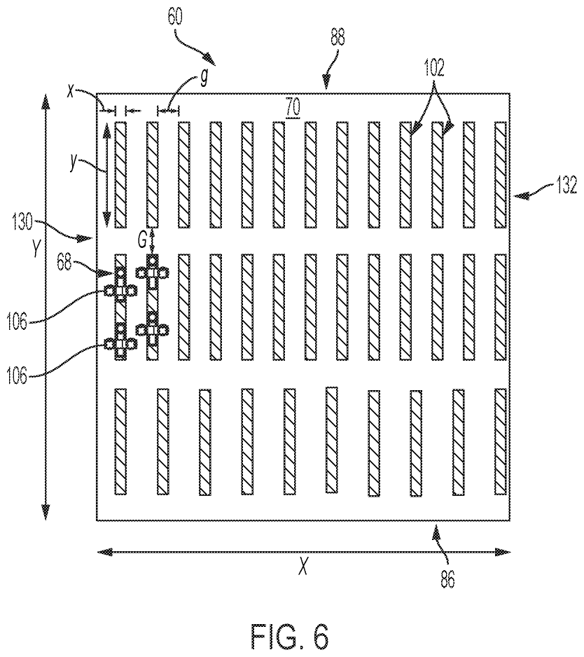

An example drum 60 is shown in a cut and rolled out view in FIG. 6. where sides 130, 132 represent the location of the cut in a cross-process direction. Multiple grooves 104 are arranged on the inner surface 70 of the drum, e.g. in one or more rows of grooves (three rows in the illustrated embodiment). Each row may include, for example, from four to twenty grooves 104, depending on the size of the cylinder. The exemplary grooves are aligned such that their largest dimension y is aligned with the cross-process dimension Y of the drum. Y is suitably sized to accommodate the width of the largest sheets to be processed. For example, Y may be from 40 to 60 cm. Dimension y is less than Y and may be, for example, from 5 to 20 cm, or more, such as 10 to 15 cm in the exemplary embodiment. The grooves may be equally spaced around the interior of the drum, for example spaced by a gap g in the process direction, of 1 to 5 cm, such as 2 to 3 cm, and a similar gap G in the cross-process direction Y of 1 to 6 cm, such as 3 to 5 cm. The grooves have a width x which can snuggly accommodate the first portions 100 of the heat pipes, e.g., 0.5 to 2 cm. The grooves 104 may extend as far as the first and second ends 86, 88 of the drum, or be set back from the ends, as illustrated, by a gap.

As an illustration, if there are three rows of twelve grooves around the interior, each groove accommodating two heat pipes, a total of 72 heat pipes (24 heat pipes per row) could be contained within each drum. As will be appreciated, fewer or more heat pipes may be used.

To balance out the rate of heat removal in the cross-process direction, the heat pipes may be spaced more closely together adjacent to the outlet end 88 of the drum, where the cooling air has already been heated by some of the heat pipes, than adjacent to the inlet end 86. This may be achieved by placing the grooves closer together and/or by fitting more heat pipes in each groove. For example, the first row of grooves (adjacent to the inlet end 86) could accommodate 20 heat pipes, the middle row 24 heat pipes, and the last row (adjacent to the outlet end 88) could accommodate 26 heat pipes. Through experimentation, the optimal distribution of heat pipes in the cross-process direction Y to maintain an even temperature in the cross-process direction on the exterior of the drum can be determined for the printer parameters used (e.g., speed, thickness of paper, temperature of the heated sheets, airflow rate, and the like).

The heat pipes 68 are provided in sufficient number to cool the printed sheets to a temperature such that they reenter the marking device 18 at a temperature which does not exceed the maximum operating temperature of the printheads. For example, the cooling device 22 may cool the sheets by at least 10° C. or at least 20° C. The temperature of the sheets reentering the marking device can also be controlled to be within an optimal range. In one embodiment, the cooling system 22 is reconfigurable on site by adding heat pipes to the drums 62, 64, removing heat pipes from the drums, and/or adjusting the number of heat pipes in each row.

To form a heat pipe 68, a cylindrical wick may be inserted into tube that is open at one end and closed at the other, which is to form the heat pipe shell 94. An amount of working fluid is added to the tube and the tube heated to convert some of the working fluid to vapor. The open end of the tube is then sealed, creating a partial vacuum inside the shell as the vapor cools. For angled heat pipes, the tube may be bent before or after it is sealed. For flattened heat pipes, the tube may be partially flattened before or after it is sealed.

The exemplary cooling device 22 using heat pipes 68 to increase heat removal from the sheets has several advantages. For example, faster printer speeds can be used without risking damage to the printheads. Additionally, heavier weights of paper can be printed at higher speeds. There are also image quality benefits arising from the paper being within a specific temperature range.

The exemplary heat pipes are able to pull heat away from the drum surface and into the air stream passively and rapidly, thus facilitating increased speeds and image quality improvements.

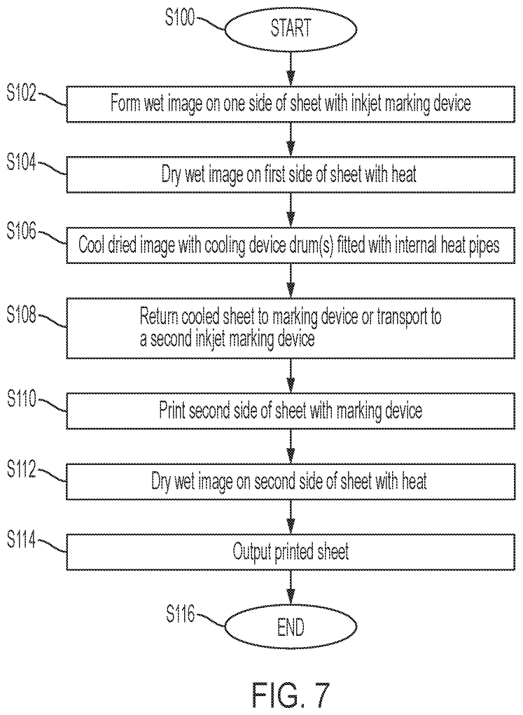

FIG. 7 illustrates a method of cooling printed sheets which may be performed with the exemplary printing device 10 or 10′. The method begins at S100.

At S102, sheets 14 are fed to an inkjet marking device 18, which forms an image on one side of a sheet using droplets of ink of one or more colors.

At S104, the printed sheets are fed to a dryer 20, which raises the temperature of the sheets. The sheets may leave the dryer at a temperature well above an acceptable temperature for entry to an inkjet marking device.

At S106, the heated, printed sheets are transported to the cooling device 22, and directed around the one or more cooling drums 60, 62. The sheets give up at least a portion of their excess heat to the drums, which, in turn, dissipate the heat through the heat pipes 68.

At S108, the cooled sheets are transported to an inkjet marking device for printing on the other side, reaching the marking device 18 (or a second marking device 18′) at a safe temperature, i.e., one which is not likely to risk harm to the printheads.

At S110, the cooled sheets are printed with the marking device 18 or 18′.

At S112, the reprinted sheets are dried in the dryer 20 (or a second dryer 20′).

At S114, the duplex printed sheets are output. The dried sheets may pass through the cooling device 22 (or a second cooling device) or bypass the cooling device at this stage.

The method ends at S116.

Some or all of the steps of the method may be performed under the control of the controller.

As will be appreciated, the method may be used for printing images on the same side of a sheet in two separate inkjet printing steps. For example, the first inkjet marking device 18 of FIG. 2 could be used to apply one or more conventional inks to form an image on the first side the sheet and the second marking device 18′ could be used to apply a custom color, transparent coating, metallic ink, or the like on top of the image on the first side of the sheet.

The heat pipe shape could additionally be modified to optimize contact with the drum on one end, and air transfer on the other.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A cooling device for cooling sheets comprising:
a drum mounted for rotation about a central axis, the drum including a cylindrical wall which defines an outer surface and an inner surface;
a plurality of heat pipes extending into an interior of the drum from the inner surface of the cylinder wall.

2. The cooling device of claim 1, wherein each of the plurality of heat pipes includes a shell, a wicking material and a working fluid which is enclosed within the shell.

3. The cooling device of claim 2, wherein the working fluid comprises water.

4. The cooling device of claim 2, wherein each of the plurality of heat pipes defines a void, the working fluid traveling through the void towards a cooler end of the heat pipe when the working fluid evaporates.

5. The cooling device of claim 1, wherein each of the plurality of heat pipes has a length L and an interior diameter D, a ratio of L:D being at least 3:1.

6. The cooling device of claim 1, wherein each of the plurality of heat pipes includes a first portion, adjacent to the cylinder wall, and a second portion, extending from the first portion, exterior surfaces of the first and second portions defining an angle of from 110° to 170° therebetween.

7. The cooling device of claim 6, wherein the first and second portions of each of the plurality of heat pipes together define a void, the working fluid traveling through the void towards a cooler end of the heat pipe when the working fluid evaporates.

8. The cooling device of claim 6, wherein a length L1 of the first portion of each of the plurality of heat pipes is greater than a length L2 of the second portion of each of the plurality of heat pipes.

9. The cooling device of claim 6, wherein the inner surface of the cylinder wall defines a plurality of grooves, each groove receiving the first portion of at least one of the plurality of heat pipes.

10. The cooling device of claim 1, wherein each of the plurality of heat pipes includes a plurality of protrusions which provide an increased exterior surface area of the heat pipe, and optionally, wherein each of the plurality protrusions defines an interior which is accessible to a working fluid within the heat pipe.

11. The cooling device of claim 1, the drum further comprising an inlet at a first end of the drum, through which cooling fluid enters the drum interior, and an outlet at a second end of the drum, through which cooling fluid leaves the drum interior.

12. The cooling device of claim 1, further comprising a biasing mechanism for biasing the sheets into contact with the outer surface of the cylindrical wall.

13. The cooling device of claim 12, wherein the biasing mechanism comprises at least one of rollers and a continuous belt.

14. The cooling device of claim 1, wherein the drum includes first and second counter-rotating drums.

15. The cooling device of claim 14, wherein each of the first and second counter-rotating drums contains at least 12 heat pipes.

16. A printing device comprising:
the cooling device of claim 1;
a first inkjet marking device;
a dryer which heats sheets that have been printed with the inkjet marking device, the cooling device receiving heated sheets from the dryer; and
a paper path which transports sheets from the cooling device to one of the first inkjet marking device and a second inkjet marking device.

17. A method of printing comprising:
printing a first side of a sheet with a first inkjet marking device;
drying the sheet that has been printed with the first inkjet marking device to form a heated sheet;
cooling the heated sheet with a cooling device which includes a plurality of heat pipes which draw heat from the sheet to form a cooled sheet; and
transporting the cooled sheet from the cooling device to one of the first inkjet marking device and a second inkjet marking device for printing on one of the first side and a second side of the sheet.

18. The method of printing of claim 17, wherein the cooling device comprises a cylindrical wall, the sheets contacting an outer surface of the cylindrical wall, the heat pipes extending from an inner surface of the cylindrical wall.

19. The method of printing of claim 17, further comprising exposing the heat pipes to a flow of cooling air.

20. A method of forming a cooling device comprising:
attaching a plurality of heat pipes to an inner surface of a cylindrical wall of a drum, such that the heat pipes extend into an interior of the drum;
mounting the drum for rotation about a central axis;
connecting a source of cooling air with the interior of the drum; and
providing a paper path for sheets to contact an outer surface of the cylindrical wall during rotation of the drum.
